(19) United States
(12) Patent Application Publication
(10) Pub. No.: US 2007/0129504 A1
(43) Pub. Date: Jun. 7, 2007

(54) Composition

(76) Inventors: Huiping Zhang, Evansville, IN (US); Parminder Agarwal, Evansville, IN (US); Rodney W. Fonseca, Newburgh, IN (US); Peter H. Th. Vollenberg, Evansville, IN (US)

Correspondence Address: GEAM - O8CV - CPP;IP LEGAL, ONE PLASTICS AVENUE, PITTSFIELD, MA, 01201-3697, US

(21) Appl. No.: 11/294,074

(22) Filed: Dec. 5, 2005

(51) Int. Cl. C08L 67/02; C08L 83/10

(52) U.S. Cl. 525/446; 525/464

(57) ABSTRACT

A composition comprising about 5 to about 90 wt % of a polysiloxene polycarbonate block copolymer, about 10 to about 80 wt % of a cycloaliphatic polyester, and zero to about 85 wt % of a polycarbonate

### BACKGROUND OF THE INVENTION

Blends of polycarbonates and polyester have been known for several decades. Property wise they represent an amalgamation of various properties of the two polymer systems—some properties of one being boosted, but usually at the expense of the other polymer's property. Some of the areas which could use overall improvement are impact, particularly low temperature impact, and solvent resistance. Through the addition of a copolycarbonate system, we have maintained light transmission characteristics of the polycarbonate polyester system while significantly improving its ductility particularly low temperature, after aging, and in the presence of steam, while having improved solvent resistance to basic organic chemical system.

### SUMMARY OF THE INVENTION

In accordance with the invention, there is a composition comprising
a. about 5 to about 90 wt % of a polysiloxane polycarbonate block copolymer,
b. about 10 to about 80 wt % of a cycloaliphatic polyester, and
c. zero to about 85 wt % of a polycarbonate

### DETAILED DESCRIPTION OF THE INVENTION

The singular forms “a”, “an”, and “the” include plural referents unless the context clearly dictates otherwise.

“Optional” or “optionally” as used herein means that the subsequently described event or circumstance may or may not occur, and that the description includes instances where the event occurs and instances where it does not.

The polyorganosiloxane/polycarbonate block copolymer comprises polycarbonate blocks and polyorganosiloxane blocks. The polycarbonate blocks comprise repeating structural units of the formula (I), 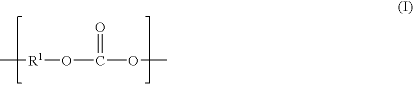
in which at least 60 percent of the total number of R¹ groups are aromatic organic radicals and the balance thereof are aliphatic, alicyclic, or aromatic radicals. R¹ may be an aromatic organic radical of the formula (II), [symbol]
A¹-Y¹-A² [symbol] (II)
wherein each of A¹ and A² is a monocyclic divalent aryl radical and Y¹ is a bridging radical having one or two atoms which separate A¹ from A². In one embodiment, one atom separates A¹ from A². Illustrative non-limiting examples of radicals of this type include —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be an unsaturated hydrocarbon group or a saturated hydrocarbon group such as methylene, cyclohexylidene or isopropylidene.

The polyorganosiloxane blocks comprise repeating structural units of the formula (III), 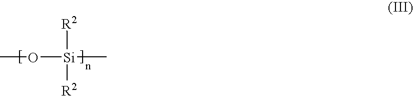
wherein R² is independently at each occurrence a monovalent organic radical having 1 to 13 carbon atoms, and “n” is an integer greater than or equal to 1, or, more specifically, greater than or equal to 10, or, even more specifically, greater than or equal to 25. In one embodiment n is greater than or equal to 40. The integer “n” may also be less then or equal to 1000, or, more specifically, less than or equal to 100, or, even more specifically, less than or equal to 75 or, even more specifically less than or equal to 60. As is readily understood by one of ordinary skill in the art, “n” represents an average value.

In one embodiment, the polyorganosiloxane blocks comprise repeating structural units of the formula (IV), 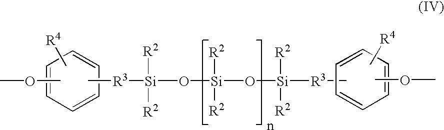
wherein R² and “n” are as defined above. R³ is independently at each occurrence a divalent aliphatic radical having 1 to 8 carbon atoms or aromatic radical having 6 to 8 carbon atoms. In one embodiment each occurrence of R³ is in the ortho or para position relative to the oxygen. R⁴ is independently at each occurrence a hydrogen, halogen, alkoxy having 1 to 8 carbon atoms, alkyl having 1 to 8 carbon atoms or aryl having 6 to 13 carbon atoms and “n” is an integer less than or equal to 1000, specifically less than or equal to 100, or, more specifically, less than or equal to 75 or, even more specifically, less than or equal to 60. As is readily understood by one of ordinary skill in the art, n represents an average value.

In one embodiment in the above formula (IV), R² is independently at each occurrence an alkyl radical having 1 to 8 carbons, R³ is independently at each occurrence a dimethylene, trimethylene or tetramethylene, R⁴ is independently at each occurrence a halogen radical, such as bromo and chloro; alkyl radical such as methyl, ethyl, and propyl; alkoxy radical such as methoxy, ethoxy, and propoxy; aryl radical such as phenyl, chlorophenyl, and tolyl. In one embodiment R³ is methyl, a mixture of methyl and trifluoropropyl, or a mixture of methyl and phenyl.

The polyorganosiloxane/polycarbonate copolymers may have a weight-average molecular weight (Mw), measured, for example, by ultra-centrifugation or light scattering, of greater than or equal to 10,000, or, more specifically, greater than or equal to 20,000. The weight average molecular weight may be less than or equal to 200,000, or, more specifically, less than or equal to 100,000. It is generally desirable to have polydimethylsiloxane units contribute 0.5 to 80 weight percent of the total weight of the polyorganosiloxane/polycarbonate copolymer or an equal molar amount of other polydiorganolsiloxanes. Even more specific is a range of about 1 to about 10 weight percent of siloxane units in the polyorganosiloxane/polycarbonate copolymer.

The polyorganosiloxane/polycarbonate block copolymer comprises polyorganosiloxane domains having an average domain size of less than or equal to 45 nanometers. Within this range the polyorganosiloxane domains may be greater than or equal to 5 nanometers. Also within this range the polyorganosiloxane domains may be less than or equal to 40 nanometers, or, more specifically, less than or equal to 10 nanometers.

Domain size may be determined by Transmission Electron Microscopy (TEM) as follows. A sample of the polyorganosiloxane/polycarbonate block copolymer is injection molded into a sample 60 millimeters square and having a thickness of 3.2 millimeters. A block (5 millimeters by 10 millimeters) is cut from the middle of the sample. The block is then sectioned from top to bottom by an ultra microtome using a diamond knife at room temperature. The sections are 100 nanometers thick. At least 5 sections are scanned by TEM at 100 to 120 kilovolts (kV) and the images recorded at 66,000× magnification. The polysiloxane domains were counted and measured, the domain size reflecting the longest single linear dimension of each domain. The domain sizes over the 5 sections were then averaged to yield the average domain size.

Also specifically envisioned are polyorganosiloxane/polycarbonate block copolymers prepared by direct synthesis comprising a polycarbonate matrix and the desired embedded polysiloxane domains. In a blend of two polyorganosiloxane/polycarbonate copolymers the individual copolymers are generally difficult to separate or to distinguish. With Transmission Electron Microscopy (TEM) it is however possible to distinguish in the blend a polycarbonate matrix and embedded polysiloxane domains.

Polyorganosiloxane/polycarbonate copolymers may be made by a variety of methods such as interfacial polymerization, melt polymerization and solid-state polymerization. For example, the polyorganosiloxane/polycarbonate copolymers may be made by introducing phosgene under interfacial reaction conditions into a mixture of a dihydric aromatic compound, such as bisphenol A (hereinafter at times referred to as BPA), and a hydroxyaryl-terminated polyorganosiloxane. The polymerization of the reactants may be facilitated by use of a tertiary amine catalyst or a phase transfer catalyst.

The hydroxyaryl-terminated polyorganosiloxane may be made by effecting a platinum catalyzed addition between a siloxane hydride of the formula (V), 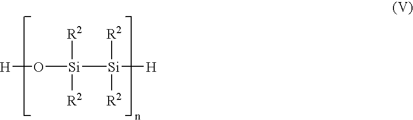
and an aliphatically unsaturated monohydric phenol wherein R² and n are as previously defined.

Non-limiting examples of the aliphatically unsaturated monohydric phenols, which may be used to make the hydroxyaryl-terminated polyorganosiloxanes include, for example, 4-allyl-2-methoxy phenol (herein after referred to as eugenol); 2-alkylphenol, 4-allyl-2-methylphenol; 4-allyl-2-phenylphenol; 4-allyl-2-bromophenol; 4-allyl-2-t-butoxyphenol; 4-phenyl-2-phenylphenol; 2-methyl-4-propylphenol; 2-allyl-4,6-dimethylphenol; 2-allyl-4-bromo-6-methylphenol; 2-allyl-6-methoxy-4-methylphenol and 2-allyl-4,6-dimethylphenol. Mixtures of aliphatically unsaturated monohydric phenols may also be used.

Among the suitable phase transfer catalysts which may be utilized are catalysts of the formula (R⁵)₄Q⁺X, where R⁵ is independently at each occurrence an alkyl group having 1 to 10 carbons, Q is a nitrogen or phosphorus atom, and X is a halogen atom, or an —OR⁶ group, where R⁶ is selected from a hydrogen, an alkyl group having 1 to 8 carbon atoms and an aryl group having 6 to 18 carbon atoms. Some of the phase transfer catalysts which may be used include [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, CH₃[CH₃(CH₂)₂]₃NX wherein X is selected from Cl⁻, Br⁻ or —OR⁶. Mixtures of phase transfer catalysts may also be used. An effective amount of a phase transfer catalyst is greater than or equal to 0.1 weight percent (wt %) and in one embodiment greater than or equal to 0.5 wt % based on the weight of bisphenol in the phosgenation mixture. The amount of phase transfer catalyst may be less than or equal to 10 wt % and more specifically less than or equal to 2 wt % based on the weight of bisphenol in the phosgenation mixture.

Non-limiting examples of dihydric aromatic compounds which may be subjected to phosgenation include, resorcinol; 4-bromoresorcinol; hydroquinone; 4,4′-dihydroxybiphenyl; 1,6-dihydroxynaphthalene; 2,6-dihydroxynaphthalene; bis(4-hydroxyphenyl)methane; bis(4-hydroxyphenyl)diphenylmethane; bis(4-hydroxyphenyl)-1-naphthylmethane; 1,1-bis(4-hydroxyphenyl)methane; 1,1-bis(4-hydroxyphenyl)ethane; 1,2-bis(4-hydroxyphenyl)ethane; 1,1-bis(4-hydroxyphenyl)-1-phenylethane; 2,2-bis(4-hydroxyphenyl)propane; 2-(4-hydroxyphenyl)-2-)3-hydroxyphenyl)propane; 2,2-bis(4-hydroxyphenyl)butane; 2,2-bis(4-hydroxyphenyl) octane; 1,1-bis(4-hydroxyphenyl)propane; 1,1-bis(4-hydroxyphenyl)n-butane; bis(4-hydroxyphenyl)phenylmethane; 2,2-bis(4-hydroxy-1-methylphenyl)propane; 1,1-bis(4-hydroxy-tert-butylphenyl)propane; 2,2-bis(4-hydroxy-3-bromophenyl)propane; 1,1-bis (hydroxyphenyl)cyclopentane; 1,1-bis(4-hydroxyphenyl)cyclohexane; 1,1-bis(4-hydroxyphenyl)isobutene; 1,1-bis(4-hydroxyphenyl)cyclododecane; trans-2,3-bis(4-hydroxyphenyl)-2-butene; 2,2-bis(4-hydroxyphenyl)adamantine; (alpha, alpha′-bis(4-hydroxyphenyl)toluene. bis(4-hydroxyphenyl)acetonitrile; 2,2-bis(3-methyl-4-hydroxyphenyl)propane; 2,2-bis(3-ethyl-4-hydroxyphenyl)propane; 2,2-bis(3-n-propyl-4-hydroxyphenyl)propane; 2,2-bis(3-isopropyl-4-hydroxyphenyl)propane; 2,2-bis(3-sec-butyl-4-hydroxyphenyl)propane; 2,2-bis(3-t-butyl-4-hydroxyphenyl)propane; 2,2-bis(3-cyclohexyl-4-hydroxyphenyl)propane; 2,2-bis(3-allyl-4-hydroxyphenyl)propane; 2,2-bis(3-methoxy-4-hydroxyphenyl)propane; 2,2-bis(4-hydroxyphenyl)hexafluoropropane; 1,1-dichloro-2,2-bis(4-hydroxyphenyl)ethylene; 1,1-dibromo-2,2-bis(4-hydroxyphenyl)ethylene; 1,1-dichloro-2,2-bis(5-phenoxy-4-hydroxyphenyl)ethylene; 4,4′-dihydroxybenzophenone; 3,3-bis(4-hydroxyphenyl)-2-butanone; 1,6-bis(4-hydroxyphenyl)-1,6-hexanedione; ethylene glycol bis(4-hydroxyphenyl)ether; bis(4-hydroxyphenyl)ether; bis(4-hydroxyphenyl)sulfide; bis(4-hydroxyphenyl)sulfoxide; bis(4-hydroxyphenyl)sulfone; 9,9-bis(4-hydroxyphenyl)fluorine; 2,7-dihydroxypyrene; 6,6′-dihydroxy-3,3,3′,3′-tetramethylspiro(bis)indane(“spirobiindane bisphenol”); 3,3-bis(4-hydroxyphenyl)phthalide; 2,6-dihydroxydibenzo-p-dioxin; 2,6-dihydroxythianthrene; 2,7-dihydroxyphenoxathin; 2,7-dihydroxy-9,10-dimethylphenazine; 3,6-dihydroxydibenzofuran; 3,6-dihydroxydibenzothiophene and 2,7-dihydroxycarbazole. Mixtures of dihydric aromatic compounds may also be used.

The polyorganosiloxane/polycarbonate block copolymer may be produced by blending aromatic dihydroxy compound with an organic solvent and an effective amount of phase transfer catalyst or an aliphatic tertiary amine, such as triethylamine, under interfacial conditions. Sufficient alkali metal hydroxide may be utilized to raise the pH of the bisphenol reaction mixture prior to phosgenation, to 10.5 pH. This may result in the dissolution of some of the bisphenol into the aqueous phase. Suitable organic solvents that may be used are, for example, chlorinated aliphatic hydrocarbons, such as methylene chloride, chloroform, carbon tetrachloride, dichloroethane, trichloroethane, tetrachloroethane, dichloropropane and 1,2-dichloroethylene; substituted aromatic hydrocarbons such as chlorobenzene, o-dichlorobenzene, and the various chlorotoluenes. Mixtures of organic solvents may also be used. In one embodiment the solvent comprises methylene chloride.

Aqueous alkali metal hydroxide or alkaline earth metal hydroxide addition may be used to maintain the pH of the phosgenation mixture near the pH set point, which may be in the range of 10 to 12. Some of the alkali metal or alkaline earth metal hydroxides, which may be employed, are for example, sodium hydroxide, potassium hydroxide, and calcium hydroxide. In one embodiment the alkali metal hydroxide used comprises sodium hydroxide.

During the course of phosgene introduction at a pH of 10 to 12, and depending upon the rate of phosgene addition, the pH may be lowered to allow for the introduction of the hydroxyaryl-terminated polyorganosiloxane. End-capping agents such as phenol, p-butylphenol, p-cumylphenol, octylphenol, nonylphenol and other mono hydroxy aromatic compounds may be used to regulate the molecular weight or to terminate the reaction.

Alternatively the polyorganosiloxane/polycarbonate copolymer may be produced by an aromatic dihydroxy compound in the presence of a phase transfer catalyst at a pH of 5 to 8 to form bischloroformate oligomers. Then to this is added a hydroxyaryl-terminated polyorganosiloxane, which is allowed to react at a pH of 9 to 12 for a period of time sufficient to effect the reaction between the bischloroformate oligomers and the hydroxyalryl-terminated polydiorganosiloxane, typically a time period of 10 to 45 minutes. Generally there is a large molar excess of chloroformate groups relative to hydroxyaryl groups. The remaining aromatic dihydroxy compound is then added, and the disappearance of chloroformates is monitored, usually by phosgene paper. When substantially all chloroformates have reacted, an end-capping agent and optionally a trialkylamine are added and the reaction phosgenated to completion at a pH of 9 to 12.

The polyorganosiloxane/polycarbonate copolymer may be made in a wide variety of batch, semi-batch or continuous reactors. Such reactors are, for example, stirred tank, agitated column, tube and recirculating loop reactors. Recovery of the polyorganosiloxane/polycarbonate copolymer may be achieved by any means known in the art such as through the use of an anti-solvent, steam precipitation or a combination of anti-solvent and steam precipitation.

The thermoplastic composition may comprise blends of two or more polyorganosiloxane/polycarbonate block copolymers. These block copolymers are transparent or translucent.

The cycloaliphatic polyester in the thermoplastic composition comprises a polyester having repeating units of the formula VI, 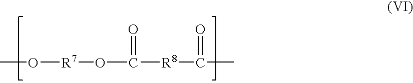
wherein R⁷ and R⁸ are independently at each occurrence an aryl, aliphatic or cycloalkane having 2 to 20 carbon atoms and chemical equivalents thereof, with the proviso that at least one of R⁷ and R⁸ is a cycloalkyl containing radical. The cycloaliphatic polyester is a condensation product where R⁷ is the residue of a diol or chemical equivalents and R⁸ is decarboxylated residue of a diacid or chemical equivalents. In one embodiment cycloaliphatic polyesters are those having both R⁷ and R⁸ as cycloalkyl containing radicals.

Cycloaliphatic polyesters may be formed from mixtures of aliphatic diacids and aliphatic diols but must contain at least 50 mole % of cyclic diacid and/or cyclic diol components, the remainder, if any, being linear aliphatic diacids and/or diols.

The cycloaliphatic polyesters may be obtained through the condensation or ester interchange polymerization of the diol or diol chemical equivalent component with the diacid or diacid chemical equivalent component.

In one embodiment R⁷ and R⁸ are cycloalkyl radicals independently selected from the following formulae VII to XVI.

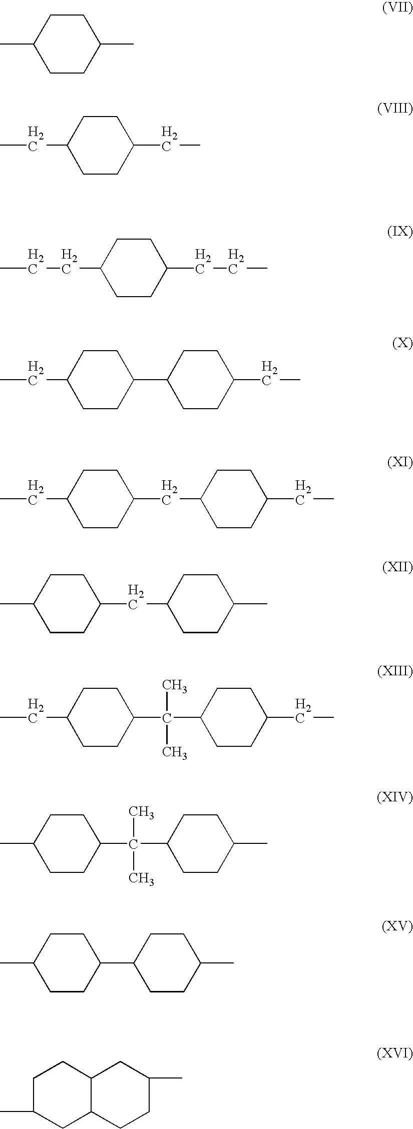

In one embodiment the cycloaliphatic radical R⁸ is derived from the 1,4-cyclohexyl diacids with generally greater than 70 mole % thereof in the form of the trans isomer and the cycloaliphatic radical R⁷ is derived from the 1,4-cyclohexyl primary diols such as 1,4-cyclohexyl dimethanol with greater than 70 mole % thereof in the form of the trans isomer. The cycloaliphatic polyesters have a weight-average molecular weight (Mw), measured, for example, by ultra-centrifugation or light scattering of 25,000 Daltons to 85,000 Daltons. The weight average molecular weight is more specifically 30,000 Daltons to 80,000 Daltons and most specifically 60,000 to 80,000 Daltons.

Other diols that may be used in the preparation of the cycloaliphatic polyester are straight chain, branched, or cycloaliphatic alkane diols and may contain 2 to 20 carbon atoms. Examples of such diols include, but are not limited to, ethylene glycol; propylene glycol, i.e., 1,2- and 1,3-propylene glycol; 2,2-dimethyl-1,3-propane diol; 2-ethyl-2-methyl-1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; 2,2,4,4-tetramethyl-1,3-cyclobutanediol (TMCBD); triethylene glycol; 1,10-decane diol; and mixtures of any of the foregoing. In one embodiment the diol or chemical equivalent thereof used is 1,4-cyclohexane dimethanol or its chemical equivalents.

Chemical equivalents to the diols include esters, such as dialkylesters, diaryl esters and the like.

In one embodiment the diacids are cycloaliphatic diacids. This is includes carboxylic acids having two carboxyl groups each of which is attached to a saturated carbon. Specific diacids are cyclo or bicyclo aliphatic acids, non-limiting examples of which include, decahydro naphthalene dicarboxylic acids, norbornene dicarboxylic acids, bicyclo octane dicarboxylic acids, 1,4-cyclohexanedicarboxylic acid or chemical equivalents. Most specifically the diacids include trans-1,4-cyclohexanedicarboxylic acid or chemical equivalent. Linear dicarboxylic acids like adipic acid, azelaic acid, dicarboxyl dodecanoic acid and succinic acid may also be useful.

In a further embodiment the diacids are aromatic diacids, for example, terephthalic acid and isophthalic acid. Cycloaliphatic or linear aliphatic diacids can be also employed in a mixture with the aromatic diacids. Terephthalic and isophthalic acids are preferred, most desirably being terephthalic acid. When there is no cycloaliphatic diacid being employed, then at least some of the diols must be cycloaliphatic diol. Various such diols have been disclosed and can be employed, the most desirable one being 1,4-cyclohexanedimethanol, as previously disclosed. Various polymers can be used with this dimethanol, particularly those with terephthalic acid such as those with low levels of cyclohexanedimethanol and high levels of ethylene glycol such as PETG, high levels of cyclohexanedimethanol and low levels of ethylene glycol such as PCTG, and all cyclohexanedimethanol such as PCT. Other aliphatic diols can be used such as butylene glycol or propylene glycol together with the cyclohexanedimethanol and other cycloaliphatic diols as previously mentioned. PETG, PCTG, and PCT are the most desirable.

Cyclohexane dicarboxylic acids and their chemical equivalents may be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. They may also be prepared by the use of an inert liquid medium in which a phthalic acid is at least partially soluble under reaction conditions and with a catalyst of palladium or ruthenium on carbon or silica.

Typically, in the hydrogenation, two isomers are obtained in which the carboxylic acid groups are in cis- or trans-positions. The cis- and trans-isomers may be separated by crystallization with or without a solvent, for example, using n-heptane, or by distillation. The cis- and trans- isomers have different physical properties and may be used independently or as a mixture. Mixtures of the cis- and trans-isomers are useful herein as well.

When the mixture of isomers or more than one diacid or diol is used, a copolyester or a mixture of two polyesters may be used as the cycloaliphatic polyester.

Chemical equivalents of these diacids may include esters, alkyl esters, e.g., dialkyl esters, diaryl esters, anhydrides, salts, acid chlorides, acid bromides, and the like. In one embodiment the chemical equivalent comprises the dialkyl esters of the cycloaliphatic diacids, and most specifically the chemical equivalent comprises the dimethyl ester of the acid, such as dimethyl-1,4-cyclohexane-dicarboxylate.

In one embodiment the cycloaliphatic polyester is poly(cyclohexane-1,4-dimethylene cyclohexane-1,4-dicarboxylate) also referred to as poly(1,4-cyclohexane-dimethanol-1,4-dicarboxylate) (hereinafter referred to as PCCD) which has recurring units of formula XVII,

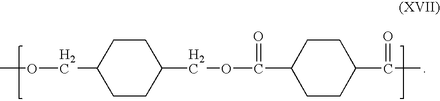

With reference to formula VI for PCCD, R⁷ is derived from 1,4-cyclohexane dimethanol; and R⁸ is a cyclohexane ring derived from cyclohexanedicarboxylate or a chemical equivalent thereof. The favored PCCD has a cis/trans formula.

The polyester polymerization reaction may be run in melt in the presence of a suitable catalyst such as a tetrakis (2-ethyl hexyl) titanate, in a suitable amount, generally 50 to 200 ppm of titanium based upon the total weight of the polymerization mixture.

In one embodiment the cycloaliphatic polyester has a glass transition temperature (Tg) greater than or equal to 50° C., or, more specifically greater than or equal to 80° C., or, even more specifically, greater than or equal to 100° C.

Also contemplated herein are the above polyesters with 1 to 50 percent by weight of units derived from polymeric aliphatic acids and/or polymeric aliphatic polyols to form copolyesters. The aliphatic polyols include glycols, such as poly(ethylene glycol) or poly(butylene glycol). Such polyesters may be made in accordance with the processes disclosed in for example, U.S. Pat. Nos. 2,465,319 and 3,047,539.

The thermoplastic composition may optionally further comprise a polycarbonate resin. Polycarbonate resins comprise repeating structural units of the formula XVIII, 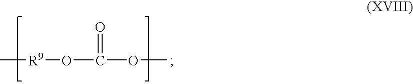
in which at least 60 percent of the total number of R⁹ groups are aromatic organic radicals and the balance thereof are aliphatic, alicyclic, or aromatic radicals. In one embodiment, R⁹ is an aromatic organic radical and, more specifically, a radical of the formula (XIX),
-A³-Y²-A⁴- (XIX);
wherein each of A³ and A⁴ is a monocyclic divalent aryl radical and Y² is a bridging radical having one or two atoms which separate A³ from A⁴. In an exemplary embodiment, one atom separates A³ from A⁴. Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y² may be a hydrocarbon group or a saturated hydrocarbon group such as methylene, cyclohexylidene or isopropylidene.

Polycarbonates may be produced by the interfacial reaction of dihydroxy compounds in which only one atom separates A³ and A⁴. As used herein, the term “dihydroxy compound” includes, for example, bisphenol compounds having general formula XX as follows: 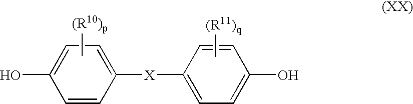
wherein R¹⁰ and R¹¹ independently at each occurrence are a halogen atom or a monovalent hydrocarbon group; p and q are each independently integers from 0 to 4; and X represents one of the groups of formula XXI or XXII, 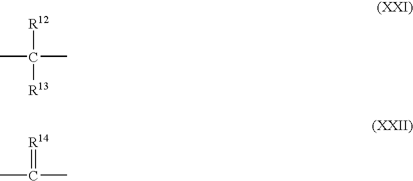
wherein R¹² and R¹³ independently at each occurrence are a hydrogen atom or a monovalent linear or cyclic hydrocarbon group having 1 to 8 carbons and R¹⁴ is a divalent hydrocarbon group having 1 to 8 carbons.

Some illustrative, non-limiting examples of suitable dihydroxy compounds include the dihydroxy-substituted aromatic hydrocarbons disclosed by name or formula (generic or specific) in U.S. Pat. No. 4,217,438. A nonexclusive list of specific examples of the types of dihydroxy compounds includes the following: resorcinol; 4-bromoresorcinol; hydroquinone; 4,4′-dihydroxybiphenyl; 1,6-dihydroxynaphthalene; 2,6-dihydroxynaphthalene; bis(4-hydroxyphenyl)methane; bis(4-hydroxyphenyl)diphenylmethane; bis(4-hydroxyphenyl)-1-naphthylmethane; 1,1-bis(4-hydroxyphenyl)methane; 1,1-bis(4-hydroxyphenyl)ethane; 1,2-bis(4-hydroxyphenyl)ethane; 1,1-bis(4-hydroxyphenyl)-1-phenylethane; 2,2-bis(4-hydroxyphenyl)propane; 2-(4-hydroxyphenyl)-2-)3-hydroxyphenyl)propane; 2,2-bis(4-hydroxyphenyl)butane; 2,2-bis(4-hydroxyphenyl) octane; 1,1-bis(4-hydroxyphenyl)propane; 1,1-bis(4-hydroxyphenyl)n-butane; bis(4-hydroxyphenyl)phenylmethane; 2,2-bis(4-hydroxy-1-methylphenyl)propane; 1,1-bis(4-hydroxy-tert-butylphenyl)propane; 2,2-bis(4-hydroxy-3-bromophenyl)propane; 1,1-bis (hydroxyphenyl)cyclopentane; 1,1-bis(4-hydroxyphenyl)cyclohexane; 1,1-bis(4-hydroxyphenyl)isobutene; 1,1-bis(4-hydroxyphenyl)cyclododecane; trans-2,3-bis(4-hydroxyphenyl)-2-butene; 2,2-bis(4-hydroxyphenyl)adamantine; (.alpha.,.alpha.′-bis(4-hydroxyphenyl)toluene. bis(4-hydroxyphenyl)acetonitrile; 2,2-bis(3-methyl-4-hydroxyphenyl)propane; 2,2-bis(3-ethyl-4-hydroxyphenyl)propane; 2,2-bis(3-n-propyl-4-hydroxyphenyl)propane; 2,2-bis(3-isopropyl-4-hydroxyphenyl)propane; 2,2-bis(3-sec-butyl-4-hydroxyphenyl)propane; 2,2-bis(3-t-butyl-4-hydroxyphenyl)propane; 2,2-bis(3-cyclohexyl-4-hydroxyphenyl)propane; 2,2-bis(3-allyl-4-hydroxyphenyl)propane; 2,2-bis(3-methoxy-4-hydroxyphenyl)propane; 2,2-bis(4-hydroxyphenyl)hexafluoropropane; 1,1-dichloro-2,2-bis(4-hydroxyphenyl)ethylene; 1,1-dibromo-2,2-bis(4-hydroxyphenyl)ethylene; 1,1-dichloro-2,2-bis(5-phenoxy-4-hydroxyphenyl)ethylene; 4,4′-dihydroxybenzophenone; 3,3-bis(4-hydroxyphenyl)-2-butanone; 1,6-bis(4-hydroxyphenyl)-1,6-hexanedione; ethylene glycol bis(4-hydroxyphenyl)ether; bis(4-hydroxyphenyl)ether; bis(4-hydroxyphenyl)sulfide; bis(4-hydroxyphenyl)sulfoxide; bis(4-hydroxyphenyl)sulfone; 9,9-bis(4-hydroxyphenyl)fluorine; 2,7-dihydroxypyrene; 6,6′-dihydroxy-3,3,3′,3′-tetramethylspiro(bis)indane(“spirobiindane bisphenol”); 3,3-bis(4-hydroxyphenyl)phthalide; 2,6-dihydroxydibenzo-p-dioxin; 2,6-dihydroxythianthrene; 2,7-dihydroxyphenoxathin; 2,7-dihydroxy-9,10-dimethylphenazine; 3,6-dihydroxydibenzofuran; 3,6-dihydroxydibenzothiophene and 2,7-dihydroxycarbazole. Mixtures of dihydroxy compounds may also be used.

It is also possible to employ two or more different dihydroxy compounds or a copolymer of a dihydric phenol with a glycol or with a hydroxy-terminated or acid-terminated polyester or with a dibasic acid or hydroxy acid in the event a carbonate copolymer rather than a homopolymer is desired for use. Polyarylates and polyester-carbonate resins or their blends may also be employed. Branched polycarbonates as well as blends of linear polycarbonate and a branched polycarbonate may be employed. The branched polycarbonates may be prepared by adding a branching agent during polymerization.

These branching agents are well known and may comprise polyfunctional organic compounds containing at least three functional groups which may be hydroxyl, carboxyl, carboxylic anhydride, haloformyl and mixtures thereof. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid and benzophenone tetracarboxylic acid. The branching agents may be added at a level of 0.05-2.0 weight percent. Branching agents and procedures for making branched polycarbonates are described in U.S. Pat. Nos. 3,635,895 and 4,001,184. Many types of polycarbonates end groups may be used in the polycarbonate composition.

In one embodiment polycarbonates are based on bisphenol A compound with formula XIX, in which each of A³ and A⁴ is p-phenylene and Y² is isopropylidene. The weight average molecular weight of the polycarbonate may be 5,000 to 100,000 daltons, or, more specifically 10,000 to 65,000 daltons, or, even more specifically, 15,000 to 35,000 daltons.

The components of the composition can be present in the following amounts—polysiloxane polycarbonate copolymer can be present in an amount of about 5 to about 90 wt % of the composition. Within this range, the copolymer can be present in an amount greater than or equal to about 15 wt %. Also within this range, the copolymer can be present in an amount less than or equal to about 60 wt %. The cycloaliphatic polyester can be present in the composition in an amount of about 10 to about 80 wt %. The polyester can be present in amounts greater than about 15 wt % and can be present in amounts less than about 50 wt %. The polycarbonate need not be present in the composition but, if it is present, should not exceed quantities of about 85 wt % of the composition. A quantity greater than or about 5 wt % of the composition can be employed. The polycarbonate when present is generally less than 70 wt %.

Parts made from the compositions of this invention are translucent or transparent. Transparent is measured as >70% transmission using ASTM D1003. Translucency is an appearance state between complete opacity and complete transparency.

The addition of the polysiloxane/polycarbonate block copolymer to the cycloaliphatic polyester blend brings about the following benefits: increased long term impact performance, better low temperature ductility, and certain specific chemical resistance.

To prepare the resin composition, the components may be mixed by any known methods. Typically, there are two distinct mixing steps: a premixing step and a melt mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device. The examples are extruded using a twin screw type extruder, where the mean residence time of the material is from about 20 s to about 30 s, and where the temperature of the different extruder zones is from about 230° C. to about 290° C.

The composition may be shaped into a final article by various techniques known in the art such as injection molding, extrusion, injection blow molding, gas assist blow molding, or vacuum forming. For the test samples below, the compositions are injection molded using VanDorn 85 with melt temperature set at 250-310° C., mold temperature set at 60° C., and cycle time from 30 to 35 s.

The following tests were run on the examples.

From the granulate, the melt volume rate (MVR) was measured according to ISO 1133 (300° C./1.2 kg, unless otherwise stated) in units of cm³/10 min.

Optical properties (transmission) are measured according to ASTM D1003 with 3.2 mm thick plaques.

Notched Izod impact strength (INI) is measured according to ASTM D256 with 3.2 mm thick Izod bars at various temperatures.

Thermal aging performance: the Izod bars are heated at 90° C. for 15 hours in any oven, then tested with INI at 23° C. according to ASTM D256. The retention of INI after annealing is utilized to characterize the thermal aging performance of a material.

Autoclave: the Izod bars are placed in any autoclave or steam sterilizer (e.g., Napco sterilizer) at 120° C. for 3.3 and 6.7 hours, respectively, then tested with INI at 23° C. according to ASTM D256. The retention of INI after autoclaving is utilized to characterize the autoclavability of a material.

Chemical Resistance: Chemical resistance against various solvents is studied. A composition having 0.3% alkyl dimethyl benzyl ammonium chloride, 0.5-5% ethylene glycol, buffered to pH 11.6 in water is tested. The test is carried out according to ISO 4599. The following test conditions are used: Duration of the test: 48 hours; Test temperature: 23° C.; Applied constant strain: 0.5%. The method of contact: immersion. After the test, the tensile test procedure according to the ASTM D638 standard is performed to determine the physical properties. The sample is considered compatible to the chemical (or resistant to the chemical) if the retention of tensile elongation at break is equal or above 80%; considered marginal if the elongation retention is between 65 and 79%; and considered incompatible if the elongation retention is below 64%.

Below are examples of the invention together with control examples without the polycarbonate polysiloxane block copolymer.

| | | compar- | compar- | compar- | | | | | | | |
|---|---|---|---|---|---|---|---|---|---|---|---|
| | | ative 1 | ative 2 | ative 3 | 1 | 2 | 3 | 4 | 5 | 6 | 7 |
| Formulations | PC, MVR = 3 | 74.2 | 0 | 49.9 | 28.1 | 0 | 54.2 | 0 | 19.1 | 34.5 | 12.4 |
| | PC, MVR = 7 | 0.0 | 35 | 0 | 0.0 | 14.7 | 0.0 | 21.6 | 0 | 0 | 0 |
| | PC, MVR = 25 | 0.0 | 38.0 | 24 | 0.0 | 27.4 | 0.0 | 21.6 | 0 | 17.0 | 5.9 |
| | PCTG | 25.0 | 26.3 | 0.0 | 15.0 | 15.0 | 20.0 | 26.3 | 42 | 0.0 | 0.0 |
| | PCT | 0.0 | 0.0 | 25 | 0.0 | 0.0 | 0.0 | 0.0 | 0 | 28.5 | 42.0 |
| | t-EXL (6 wt % siloxane) | 0.0 | 0.0 | 0.0 | 56.1 | 42.1 | 25.0 | 30.0 | 38.1 | 19.0 | 38.6 |
| Properties | % Transmission @ 3.2 mm thickness | 87 | 88 | 86 | 83 | 84 | 85 | 86 | 84 | 84 | 84 |
| | INI @ 23° C. (J/m) | 980 | 760 | 700 | 950 | 910 | 1000 | 1000 | 960 | 909 | 917 |
| | INI @ 0° C. (J/m) | 130 | 110 | 95 | 940 | 800 | 860 | 825 | 910 | 405 | 168 |
| | INI @ −30° C. (J/m) | 80 | 75 | 75 | 580 | 545 | 180 | 150 | 125 | 120 | 150 |
| | INI retention after 15 h annealing | 10% | 10% | 10% | 95% | 91% | 87% | 26% | 16% | 40% | 60% |
| | @ 90° C. | | | | | | | | | | |
| | INI retention after autoclave | 10% | 10% | NM | 90% | NM | 94% | NM | N/A | NM | N/A |
| | @ 120° C. for 3.3 h | | | | | | | | | | |
| | INI retention after autoclave | 10% | 10% | NM | 90% | NM | 85% | NM | N/A | NM | N/A |
| | @ 120° C. for 6.7 h | | | | | | | | | | |
| | Chemical resistance vs Formula 409 | NM | 0% | 0% | NM | NM | NM | NM | NM | 100% | 98% |
| | (% Retention in Tensile Elongation | | | | | | | | | | |
| | @ Break after 2 days with 0.5% strain) | | | | | | | | | | |

NM is not measure.
N/A is not applicable because heat deflection temperature at 66 psi is less than 120° C.

The invention compositions having t-EXL provide excellent initial INI, which remain very high, particularly the compositions with PCTG, when INI is measured at substantially reduced temperatures of 0° C. and −30° C. Additionally, after heating at 90° C. for 15 hours, the INI is substantially retained, particularly with PCTG. The INI retention after autoclaving is also high in the tested invention compositions. With respect to solvent resistance against a specific basic material, the PCT containing compositions demonstrate very little deterioration, if any.

1. A composition comprising
a. about 5 to about 90 wt % of a polysiloxane polycarbonate block copolymer,
b. about 10 to about 80 wt % of a cycloaliphatic polyester, and
c. zero to about 85 wt % of a polycarbonate wherein said composition has enhanced impact resistance after aging wherein said composition has enhanced impact resistance after aging.

2. The composition in accordance with claim 1 wherein the block copolymer is from about 15 to about 60 wt %

3. The composition in accordance with claim 1 wherein the polyester is about 15 to about 50 wt %.

4. The composition in accordance with claim 1 wherein the polycarbonate is from about 5 to about 70 wt %.

5. The composition in accordance with claim 2 wherein the polyester is from about 15 to about 50 wt %.

6. The composition in accordance with claim 2 wherein the polycarbonate is from about 5 to about 70 wt %.

7. The composition in accordance with claim 3 wherein the polycarbonate is from about 5 to about 70 wt %.

8. The composition in accordance with claim 6 wherein the polyester is about 15 to about 50 wt %.

9. The composition in accordance with claim 1 wherein the composition is transparent or translucent.

10. The composition in accordance with claim 9 wherein the composition is transparent.

11. A shaped article prepared from the composition of claim 1.

12. A shaped article prepared from the composition of claim 9.

13. A shaped article prepared from the composition of claim 10.

14. The composition in accordance with claim 1 wherein about 1 to about 10 wt % of the block copolymer is siloxane.

15. The composition in accordance with claim 1 wherein
a. polysiloxane polycarbonate block copolymer is from about 15 to about 60 wt %,
b. the cycloaliphatic polyester is from about 15 to about 50 wt %, and
c. the polycarbonate is from about 5 to about 70 wt %.
